(19) United States
(12) Patent Application Publication
(10) Pub. No.: US 2006/0001617 A1
(43) Pub. Date: Jan. 5, 2006

(54) Demultiplexer, display using the same, and display panel

(76) Inventors: Dong-Yong Shin, Suwon-si (KR); Do-Hyung Ryu, Suwon-si (KR)

Correspondence Address: CHRISTIE, PARKER & HALE, LLP, PO BOX 7068, PASADENA, CA, 91109-7068, US

(21) Appl. No.: 11/139,043

(22) Filed: May 27, 2005

(30) Foreign Application Priority Data
Jun. 30, 2004 (KR) 10-2004-0050607

(51) Int. Cl. G09G 3/30

(52) U.S. Cl. 345/76

(57) ABSTRACT

A display includes a display area having a plurality of data lines for transmitting a data signal representing images and a plurality of pixel circuits coupled to the plurality of data lines. The display also includes a plurality of first signal lines, a data driver coupled to the plurality of first signal lines for time-dividing a first signal corresponding to the data signal and transmitting the time-divided first signal to the plurality of first signal lines, and a demultiplexer for demultiplexing the time-divided first signal transmitted from the plurality of first signal lines to generate the data signal, and applying the data signal to at least two first and second data lines of the plurality of data lines One field has first and second subfields The demultiplexer applies the data signal to the first data line for a first period of the first subfield, and applies the data signal to the second data line for a second period of the second subfield, and the first signal is set corresponding to at least two colors.

### CROSS REFERENCE TO RELATED APPLICATION

This application claims priority to and the benefit of Korean Patent Application No. 10-2004-0050607 filed on Jun. 30, 2004, in the Korean Intellectual Property Office, the entire content of which is incorporated herein by reference.

### BACKGROUND OF THE INVENTION

1. Field of the Invention

The present invention relates to a demultiplexer and a display using the same, and more particularly to a demultiplexer for demultiplexing data currents.

2. Description of the Related Art

In general, an organic light emitting diode (OLED) display, which emits light by electrically exciting a fluorescent organic compound, displays images by driving N×M organic light emitting pixels using a voltage programming method or a current programming method. An organic light emitting pixel has a multi-layered structure including an anode layer, an organic thin film layer, and a cathode layer. The organic thin film also has a multi-layered structure including an emitting layer (EML), an electron transport layer (ETL), and a hole transport layer (HTL) in order to enhance light emitting efficiency by improving the balance of electrons and holes. The organic thin film further includes a separate electron injecting layer (EIL) and a separate hole injecting layer (HIL).

The OLED display panel may be driven using a passive matrix type driving method or an active matrix type driving method using thin film transistors (TFTs). In accordance with the passive matrix type driving method, anodes and cathodes orthogonal to each other are arranged so that desired lines may be selected and driven. In accordance with the active matrix type driving method, thin film transistors are coupled to respective ITO pixel electrodes in an OLED display panel so that the OLED display panel may be driven by a voltage maintained by the capacitance of a capacitor coupled to the gate of each thin film transistor.

The OLED display requires a scan driver for driving scan lines and a data driver for driving data lines. Since the data driver converts digital data signals to analog signals which are to be applied to all of the data lines, the data driver must have output terminals corresponding to the number of data lines. However, since the data driver is manufactured in the form of a plurality of integrated circuits and the number of output terminals contained in one integrated circuit is limited, a number of integrated circuits are required to drive all of the data lines.

### SUMMARY OF THE INVENTION

In an exemplary embodiment of the present invention, a display driving method for reducing the number of integrated circuits of a data driver and a display using the same are provided.

In one aspect of the present invention, a display includes a display, a plurality of first signal lines, a data driver and a demultiplexer. The display area includes a plurality of data lines for transmitting a data signal representing images and a plurality of pixel circuits coupled to the plurality of data lines. The data driver is coupled to the plurality of first signal lines for time-dividing a first signal corresponding to the data signal and transmits the time-divided first signal to the plurality of first signal lines. The demultiplexer demultiplexes the time-divided first signal transmitted from the plurality of first signal lines to generate the data signal, and applies the data signal to at least two of the plurality of data lines including first and second data lines. In here, the demultiplexer applies the data signal to the corresponding first data line for a first period of a first subfield of the plurality of subfields forming a field, and applies the data signal to the corresponding second data line for a second period of a second subfield of the plurality of subfields. The first signal is a signal corresponding to at least two colors.

In another aspect of the present invention, a display panel includes a display area, a data driver and a demultiplexer. The display area includes a plurality of data lines for transmitting a data signal, a plurality of scan lines for transmitting a select signal, and a plurality of pixels respectively coupled to the plurality of data lines and the plurality of scan lines. The data driver generates the data signal to be programmed into the plurality of pixel circuits, time-divides the data signal to be applied to adjacent first and second data lines of the plurality of data lines, and outputs the time-divided data signal as a first signal. The demultiplexer demultiplexes the first signal to generate the data signal and applies the data signal to the first and second data lines. In here, the display area includes pixels representing at least two colors arranged repeatedly in the row direction, and the demultiplexer applies the data signal to the data lines such that at least one non-light emitting pixel exists between adjacent light emitting pixels.

In still another aspect of the present invention, a demultiplexer demultiplexes a data signal time-divided by a data driver. In the demultiplexer, the first switch transmits the data signal to a first data line in response to a first control signal, and the second switch transmits the data signal to a second data line in response to a second control signal. The data signal is a data current corresponding to at least two colors, and the first and second control signals are alternately in different sequences in a first and second subfields.

In further another aspect of the present invention, a display panel includes a plurality of data lines for transmitting a data signal, a plurality of scan lines for transmitting a select signal, and a plurality of pixels coupled to the plurality of data lines and the plurality of scan lines, respectively. Each of the plurality of pixels includes at least two first and second pixel groups representing different colors, and one field is divided into at least two subfields. The driving method for the display panel includes: applying the select signal to the plurality of scan lines sequentially in each of the subfields; and transmitting the data signal alternately to data lines to which the first pixel group and the second pixel group are respectively coupled, while applying the select signal. In here, the first and second pixel groups are set such that at least one non-light emitting pixel exists between adjacent light emitting pixels in each of the subfields.

### BRIEF DESCRIPTION OF THE DRAWINGS

The accompanying drawings illustrate exemplary embodiments of the present invention, and, together with the description, serve to explain the principles of the invention:

FIG. 1 is a schematic diagram illustrating a display according to an exemplary embodiment of the present invention;

FIG. 2 is a circuit diagram illustrating an inner configuration of a demultiplexer according to the exemplary embodiment of the present invention;

FIG. 3 is a diagram illustrating interconnection between a demultiplexer according to a first exemplary embodiment of the present invention and pixel circuits;

FIG. 4 shows a driving timing diagram of a first subfield of a demultiplexer according to a second exemplary embodiment of the present invention;

FIG. 5 is a diagram showing pixels lighted in the first subfield;

FIG. 6 shows a driving timing diagram for a second subfield of the demultiplexer according to the second exemplary embodiment of the present invention;

FIG. 7 is a diagram showing pixels lighted in the second subfield;

FIG. 8 is a diagram illustrating an interconnection between a demultiplexer according to a third exemplary embodiment of the present invention and subpixel circuits;

FIG. 9 is a diagram illustrating an interconnection between a demultiplexer according to a fourth exemplary embodiment of the present invention and subpixel circuits;

FIG. 10 shows a driving timing diagram of the first subfield of the demultiplexer according to the third and fourth exemplary embodiments of the present invention; and

FIG. 11 shows a driving timing diagram of the second subfield of the demultiplexer according to the third and fourth exemplary embodiments of the present invention.

### DETAILED DESCRIPTION

In the following detailed description, only certain exemplary embodiments of the present invention are shown and described, simply by way of illustration. As those skilled in the art would realize, the described embodiments may be modified in various different ways, all without departing from the spirit or scope of the present invention.

Accordingly, the drawings and description are to be regarded as illustrative in nature, and not restrictive. There may be parts shown in the drawings, or parts not shown in the drawings, that are not discussed in the specification as they are not essential to a complete understanding of the invention. Like reference numerals designate like elements. The phrases such as “one thing is coupled to another” can refer to either “a first one is directly coupled to a second one” or “the first one is electrically coupled to the second one with a third one provided between”.

Hereinafter, a demultiplexer and a display using the demultiplexer according to exemplary embodiments of the present invention will be described in detail.

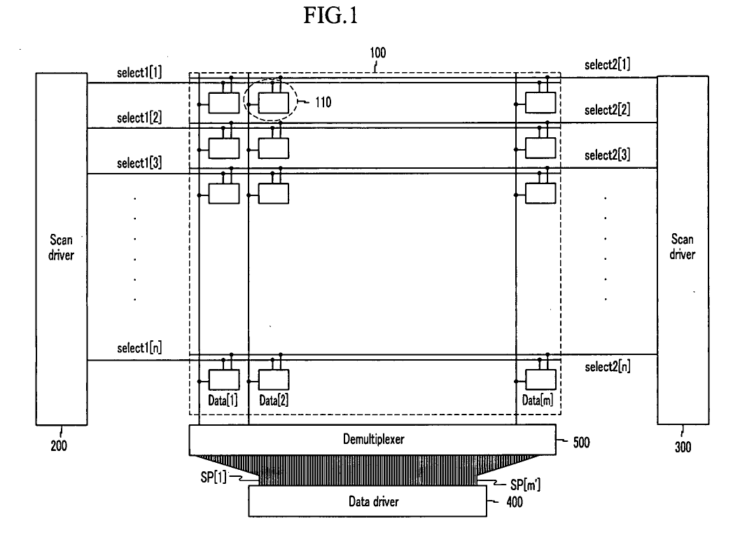

FIG. 1 is a schematic diagram illustrating a display according to an exemplary embodiment of the present invention.

As shown in FIG. 1, the display according the exemplary embodiment of the present invention includes a display panel 100, scan drivers 200 and 300, a data driver 400, and a demultiplexer 500.

The display panel 100 includes a plurality of data lines Data[1] to Data[m], a plurality of select scan lines select1[1] to select1[n], a plurality of light emit scan lines select2[1] to select2[n], and a plurality of pixel circuits 110. The plurality of data lines Data[1] to Data[m] extend in a column direction and transmit data currents representing images to the pixel circuits 110. The plurality of select scan lines select1[1] to select1[n] and the plurality of light emit scan lines select2[1] to select2[n] extend in a row direction and transmit select signals and emission control signals to the pixel circuits 110, respectively. Each pixel circuit 110 is formed in an area defined by two adjacent data lines and two adjacent scan lines, which may be any two adjacent data lines or scan lines.

The scan driver 200 applies the select signals to the select scan lines select1[1] through select1[n], and the scan driver 300 applies the emission control signals to the light emit scan lines select2[1] through select2[n]. The data driver 400 outputs the data currents to the demultiplexer 500 through a plurality of signal lines SP[1] through SP[m′], and the demultiplexer 500 demultiplexes the data currents inputted through the signal lines SP[1] through SP[m′] and transmits the demultiplexed data currents to the data lines Data[1] through Data[m].

In this exemplary embodiment, the demultiplexer 500 is a 1:2 demultiplexer which divides the data signal inputted from the data driver 400 such that the data signal may be applied to two data lines. In alternative exemplary embodiments, the demultiplexer 500 may be for example 1:3, 1:4, . . . , 1:N demultiplexers, where N should be set to be less than 3.

The scan drivers 200 and 300, the data driver 400, and/or the demultiplexer 500 may be coupled to the display panel 100, or may be mounted in the form of a chip on a tape carrier package (TCP), a flexible printed circuit (FPC), or a film conductively bonded to the display panel 100. In alternative embodiments, the scan drivers 200 and 300, the data driver 400, and/or the demultiplexer 500 may be directly mounted on a glass substrate of the display panel 100, or may be replaced with a driving circuit formed in the same layer as the scan lines, the data lines and thin film transistors or may be directly mounted on the driving circuit.

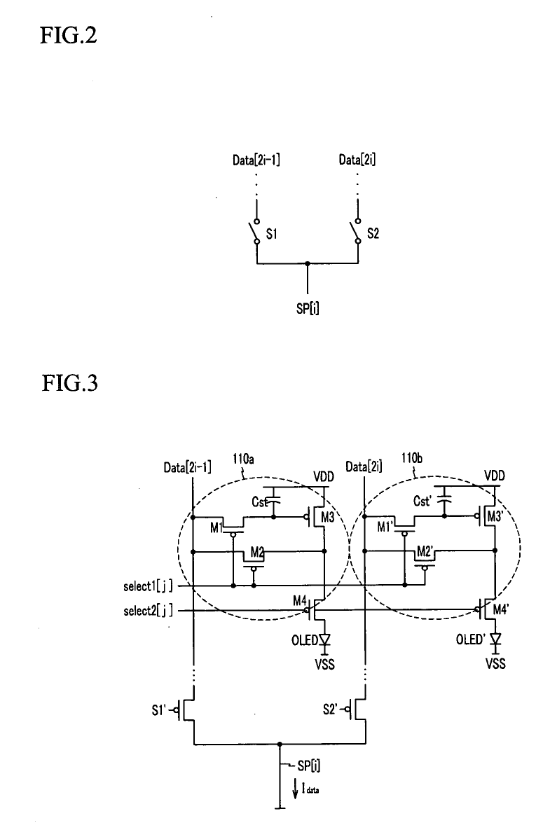

Hereinafter, the demultiplexer 500 according to the exemplary embodiment of the present invention will be described with reference to FIG. 2.

FIG. 2 is a circuit diagram illustrating an inner configuration of a demultiplexer according to an exemplary embodiment of the present invention.

As shown in FIG. 2, the demultiplexer 500 is coupled to the data driver 400 through the signal lines SP[1] to SP[m′] and transmits the data signal applied from one signal line SP[i] to two data lines Data[2i−1] and Data[2i]. The one signal line SP[i] is coupled to two switches S1 and S2, which are respectively coupled to the two data lines Data[2i−1] and Data[2i].

The switches S1 and S2 are alternately turned on/off in response to a control signal applied thereto, and respectively transmit the data signal from the signal line SP[i] to the data lines Data[2i−1] and Data[2i]. In one exemplary embodiment, the switches S1 and S2, may be NMOS or PMOS transistors or other similar switches.

Next, operation of a demultiplexer according to a first exemplary embodiment of the present invention will be described with reference to FIG. 3.

FIG. 3 is a diagram illustrating an interconnection between the demultiplexer according to the first exemplary embodiment of the present invention and one or more pixel circuits. FIG. 3 shows two pixel circuits 110a and 110b coupled to data lines Data[2i−1] and Data[2i] and scan lines select1[j] and select2[j].

The pixel circuit 110a includes transistors M1 through M4, a capacitor Cst, and an OLED element (OLED). The pixel circuit 110b includes transistors M1′ through M4′, a capacitor Cst′, and an OLED element (OLED′).

First, when a select signal from the scan line select1[j] has a low level, the transistors M1, M2, M1′ and M2′ are turned on. If, at the same time, a switch S1′ is turned on, the data signal from the signal line SP[i] is applied to the pixel circuit 110a through the data line Data[2i−1]. Thus, the transistor M3 is diode-coupled by the transistors M1 and M2 and a voltage corresponding to the data signal from the data line Data[2i−1] is programmed into the capacitor Cst.

Next, when a switch S2′ is turned on, the data signal from the signal line SP[i] is applied to the pixel circuit 110b through the data line Data[2i]. Thus, the transistor M3′ is diode-coupled by the transistors M1′ and M2′, and a voltage corresponding to the data signal from the data line Data[2i] is programmed into the capacitor Cst. At this time, since the switch S1′ is turned off, a current of 0 A or no current flows through the data line Data[2i−1] and a voltage corresponding to 0 A (i.e., blank signal) is programmed into the capacitor Cst.

Accordingly, when the transistors M4 and M4′ are turned on by an emission control signal from the scan line select2[j] causing the pixel circuits 110a and 110b to emit light, the current 0 A or no current flows into the OLED element (OLED) in the pixel circuit 110a. Accordingly, the pixel circuit 110a goes into a blank state where an original gray scale is not represented.

To overcome this problem, separate additional scan lines for the pixel circuits 110a and 110b may be used. However, this method results in increased interconnection and a decreased aperture ratio and requires an additional scan driver for controlling the additional scan lines which raises production costs.

To avoid this disadvantage, a demultiplexer according to a second exemplary embodiment of the present invention divides one field into a plurality of subfields and programs a data current into two adjacent pixel circuits alternately.

In the following description, a case where one field is divided into first and second subfields, and the data current is alternately programmed into two adjacent pixel circuits in the first and second subfields, will be mainly described. However, it is to be understood that the division of the field may be altered in various exemplary embodiments. For example, one field may be divided into three or more subfields, and different subfields may have different lengths.

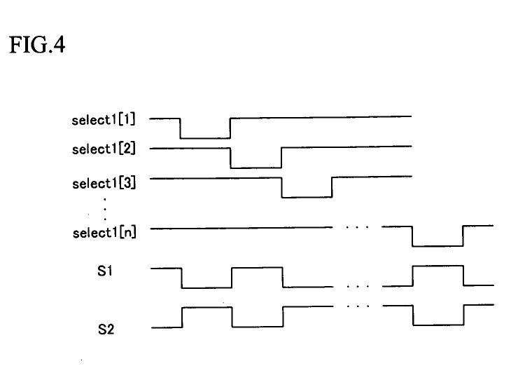

Hereinafter, operation of the demultiplexer according to the second exemplary embodiment of the present invention is described with reference to FIGS. 4 to 7.

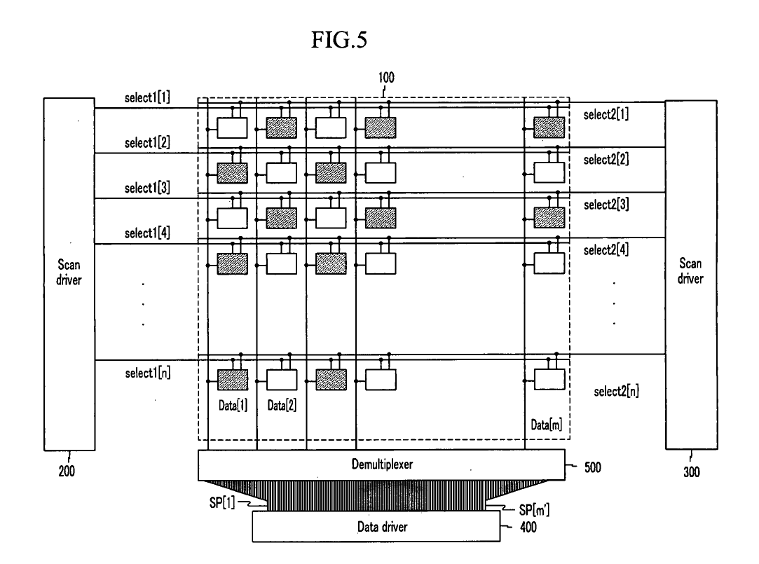

First, operation of the demultiplexer in the first subfield will be described with reference to FIGS. 4 and 5. FIG. 4 shows a driving timing diagram of the first subfield of the demultiplexer, and FIG. 5 is a diagram showing pixels illuminated in the first subfield. The pixels that are turned on in the first field are the ones that are not shown as grayed or blacked out in FIG. 5.

As shown in FIG. 4, in the first subfield, while a select signal is applied to scan lines select1[1] to select1[n] the switches S1 and S2 are alternately turned on and off.

More specifically, when the select signal is applied to the scan line select1[1], the switch S1 is turned on and the switch S2 is turned off. In this case, a data signal is applied to only a data line Data[2i−1] and the data signal is not applied to a data line Data[2i]. Accordingly, when an emission control signal is applied to a scan line select2[1], a pixel circuit 110a coupled to the scan line select1[1] and the data line Data[2i−1] emits light and a pixel circuit 110b coupled to the scan line select1[1] and the data line Data[2i] goes into a blank state and therefore does not emit light.

The emit signal can be applied to the scan line select2[1] after an enable interval of the select signal applied to the scan line select1[1]. Alternatively, when scan lines select2[1] through select2[n] for transmitting the emission control signal are removed, NMOS transistors are used as the transistors M4 and M4′ in the pixel circuit of FIG. 3, and gate electrodes of the transistors M4 and M4′ are coupled to the scan line select1[1 ] to select1[n], then the pixel circuit may emit light at the same time as the end of the enable interval of the select signal.

Next, when the select signal is applied to a scan line select1[2], the switch S2 is turned on and the switch S1 is turned off. Then, the data signal is applied to the data line Data[2i] only; as a result, the data signal is not applied to the data line Data[2i−1]. Accordingly, when the an emission control signal is applied to a scan line select2[2], a pixel circuit (not shown) coupled to the scan line select1[2] and the data line Data[2i] emits light, and a pixel circuit (not shown) coupled to the scan line select1[2] and the data line Data[2i−1] goes into a blank state and therefore does not emit light.

In this way, while the select signal is applied to scan lines select1[3] through select1[n], by turning the switch S1 and the switch S2 alternately on and off, the data signal is sequentially applied to the data lines Data[2i−1] and Data[2i]. Thus, as shown in FIG. 5, in the first subfield, the data signal is programmed only into pixel circuits coupled to odd-numbered scan lines select1[2j−1] and odd-numbered data lines Data[2i−1] and pixel circuits coupled to even-numbered scan lines select1[2j] and even-numbered data line Data[2i]. The pixel circuits into which the data signal is programmed emit light until the pixel circuits go into a blank state by the second subfield (i.e. for about ½ of one field). Accordingly, the duration of light emission of the pixel circuits may be reduced by adjusting the timing of the an emission control signal.

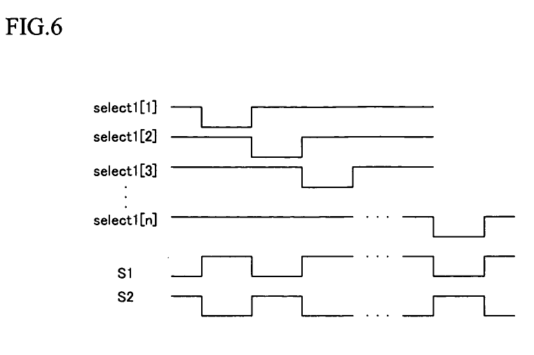

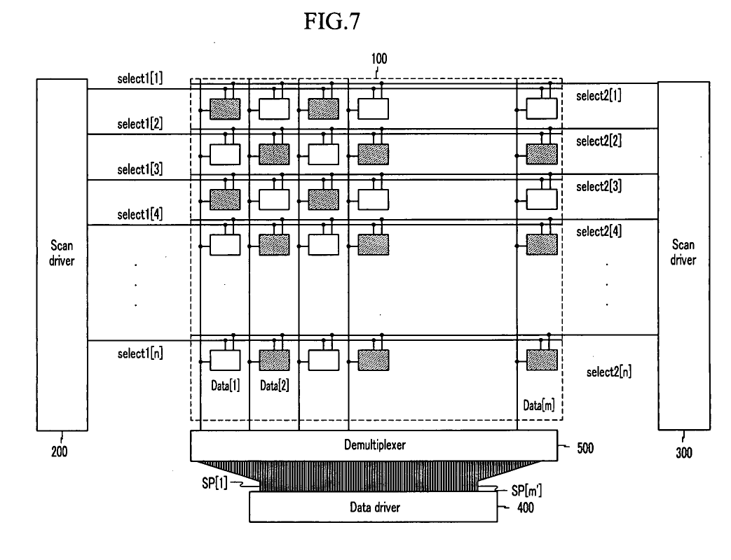

Hereinafter, operation of the demultiplexer in the second subfield will be described with reference to FIGS. 6 and 7. FIG. 6 shows a driving timing diagram of the second subfield of the demultiplexer, and FIG. 7 is a diagram showing pixels illuminated in the second subfield. The pixels that are turned on in the first field are the ones that are not shown as grayed or blacked out in FIG. 7.

As shown in FIG. 6, in the second subfield, while the select signal is applied to the scan lines select1[1] through select1[n], the switches S2 and S1 are switched on and off such that the data signal is alternately applied to two adjacent data lines Data[2i] and Data[2i−1].

In the embodiment shown of the second subfield, the switches S1 and S2 are turned on and off in an opposite way to the first subfield, such that the pixel circuits lighted in the first subfield are not lighted in FIG. 7 by an equivalent operation of the switches S1 and S2.

In this way, since the driving method according to the second exemplary embodiment of the present invention employs a duty driving method where pixels emit light approximately one half of one field, the amount of the data current can be twice that in conventional driving methods, which may overcome a problem of reduction of data programming time due to the use of the demultiplexer.

In addition, since adjacent pixel circuits are alternately lightened in the duty driving method according to the second exemplary embodiment of the present invention, flickers occurring in conventional duty driving methods can also be reduced.

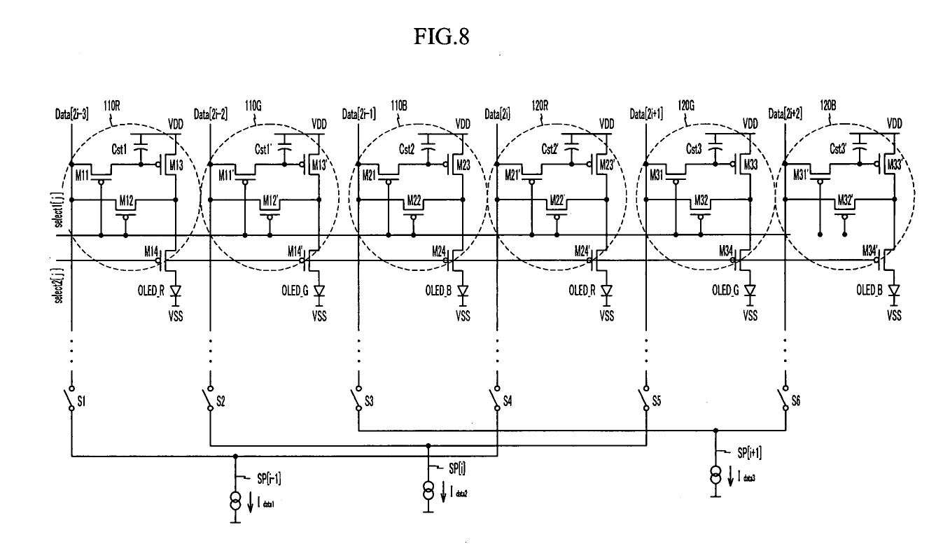

Hereinafter, a driving method of a pixel including a plurality of subpixels will be described with reference to FIGS. 8 through 11.

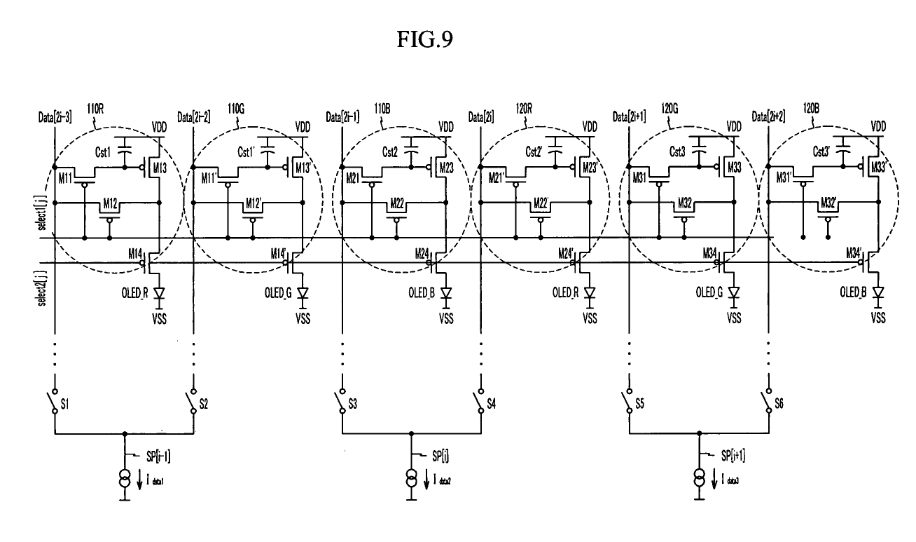

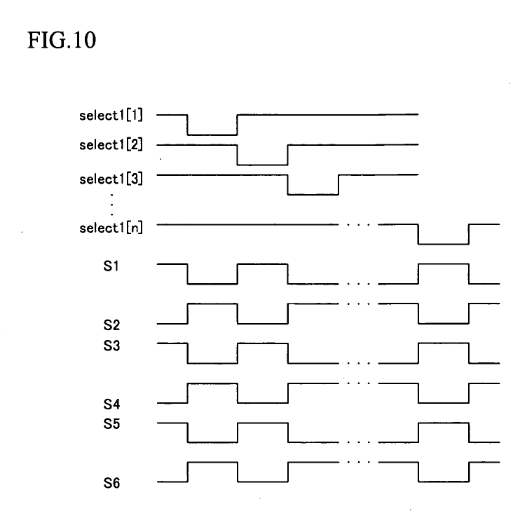

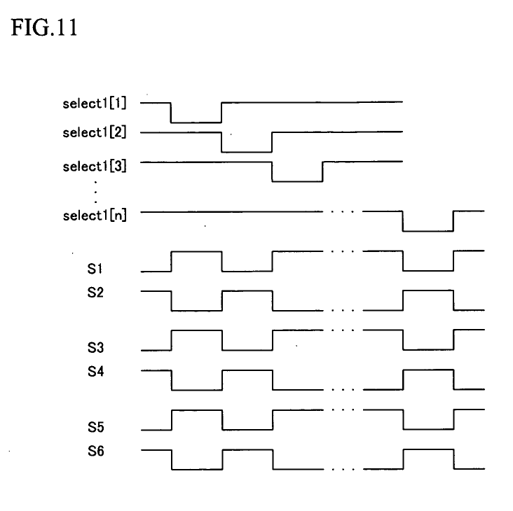

FIGS. 8 and 9 are diagrams illustrating interconnection between a demultiplexer and a subpixel circuit according to third and fourth exemplary embodiments of the present invention respectively, and FIGS. 10 and 11 show driving timing diagrams in the first and second subfields of the demultiplexer according to the third and fourth exemplary embodiments of the present invention respectively.

In FIGS. 8 and 9, red, green and blue subpixels are alternately arranged in rows and columns. Although the figures show two red, two green, and two blue subpixels, more subpixels may be provided in the same pattern as in FIGS. 8 and 9.

On the other hand, hereinafter, a pixel including subpixels 110R, 110G and 110B is called a first pixel and a pixel including subpixels 120R, 120G and 120B is called a second pixel.

According to the third exemplary embodiment of the present invention, as shown in FIG. 8, each signal line SP[i−1], SP[i] and SP[i+1] is coupled to a data signal of a subpixel to represent the same color subpixel as the adjacent first and second pixels, and transmits a data current corresponding to one color.

More specifically, a data current corresponding to a red color is applied to the signal line SP[i−1], and is alternately applied to data lines Data[2i−3] and Data[2i] through switches S1 and S2.

A data current corresponding to a green color is applied to the signal line SP[i], and is alternately applied to data lines Data[2i−2] and Data[2i+1] through switches S3 and S4.

A data current corresponding to a blue color is applied to the signal line SP[i+1], and is alternately applied to data lines Data[2i−1] and Data[2i+2] through the switches S5 and S6.

Hereinafter, operation of the demultiplexer according to the third exemplary embodiment of the present invention will be described in detail with reference to FIGS. 10 and 11.

In the first subfield, while a select signal is applied to scan lines select1[1] to select1[n], switches S1 to S6 are turned on and off such that a data signal is alternately applied to two data lines coupled to one signal line.

That is, when the switches S1, S3 and S5 are turned on and the switches S2, S4 and S6 are turned off while the select signal is applied to the scan line select1[1], a data signal is applied to only data lines Data[2i−3], Data[2i−2] and Data[2i−1] and the data signal is not applied to data lines Data[2i], Data[2i+1] and Data[2i+2].

Accordingly, when an emit signal is applied to a scan line select2[1], subpixels 110R, 110G and 110B of the first pixel emit light and subpixels 120R, 120G and 120B of the second pixel do not emit light. Therefore, only the first pixel emits light to display an image corresponding to the data signal.

Thereafter, when the switches S2, S4 and S6 are turned on and the switches S1, S3 and S5 are turned off while the select signal is applied to the scan line select1[2], a data signal is applied to only the data lines Data[2i], Data[2i+1] and Data[2i+2] and the data signal is not applied to the data lines Data[2i−3], Data[2i−2] and Data[2i−1].

Accordingly, when an emission control signal is applied to a scan line select2[2], a pixel (not shown) including subpixels coupled to the scan line select1[2] and the data lines Data[2i], Data[2i+1] and Data[2i+2] emits light, and another pixel (not shown) including subpixels coupled to the scan line select1[2] and the data lines Data[2i−3], Data[2i−2] and Data[2i−1] does not emit light.

In this way, while the select signal is applied to scan lines select1[3] through select1[n], by alternately turning on and off the switches S1 to S6, the data signal is programmed into only odd-numbered subpixels of pixels coupled to odd-numbered scan lines and even-numbered subpixels of pixels coupled to even-numbered scan lines. The pixels into which the data signal is programmed emit light until the pixels go into the blank state by the second subfield.

In the second subfield, the switches S1 to S6 are turned on and off in an opposite way to that of the first subfield such that the pixels lighted in the first subfield are not lighted in the second subfield.

Therefore, when the switches S2, S4 and S6 are turned on and the switches S1, S3 and S5 are turned off while the select signal is applied to the scan line select1[1], a data signal is applied to only data lines Data[2i], Data[2i+1] and Data[2i+2], and not to data lines Data[2i−3], Data[2i−2] and Data[2i−1].

Accordingly, when an emission control signal is applied to a scan line select2[1], subpixels 120R, 120G and 120B of the second pixel emit light and subpixels 110R, 110G and 110B of the first pixel do not emit light; only the second pixel emits light to display an image corresponding to the data signal.

Thereafter, when the switches S1, S3 and S5 are turned on and the switches S2, S4 and S6 are turned off while the select signal is applied to the scan line select1[2], a data signal is applied to the data lines Data[2i−3], Data[2i−2] and Data[2i−1] and the data signal is not applied to the data lines Data[2i], Data[2i+1] and Data[2i+2].

Accordingly, when an emission control signal is applied to the scan line select2[2], subpixels coupled to the scan line select1[2] and the data lines Data[2i−3], Data[2i−2] and Data[2i−1] emit light, and subpixels coupled to the scan line select1[2] and the data lines Data[2i], Data[2i+1] and Data[2i+2] do not emit light.

In this way, while the select signal is applied to scan lines select1[3] to select1[n], by alternately turning on and off the switches S1 to S6, the data signal is programmed into only even-numbered subpixels of pixels coupled to odd-numbered scan lines and odd-numbered subpixels of pixels coupled to even-numbered scan lines.

Thus, by alternately lighting adjacent pixels according to the third exemplary embodiment of the present invention, the amount of the data current can be twice that of conventional driving methods, and flickers occurring in conventional duty driving methods can also be reduced.

However, when one field is divided into a plurality of subfields and a pixel unit is lighted in each subfield as in the third exemplary embodiment of the present invention, a pattern of pixels which do not emit light in each subfield (i.e., black pixels) may appear instantaneously. There is a problem in that this pattern may be perceived by an observer. If at least one non-light emitting pixel exists between two adjacent light emitting pixels in vertical and horizontal directions, the size and number of non-light emitting pixels has the potential to have a significant effect on the image quality of the display.

FIG. 9 is a diagram illustrating an interconnection between a demultiplexer and subpixels according to the fourth exemplary embodiment of the present invention.

As shown in FIG. 9, a data current corresponding to a red color and a data current corresponding to a green color are alternately applied to a signal line SP[i−1], switches S1 and S2 are alternately turned on and off, and the data current is accordingly programmed into data lines Data[2i−3] and Data[2i−2].

In addition, a data current corresponding to a blue color and a data current corresponding to the red color are alternately applied to a signal line SP[i], switches S3 and S4 are alternately turned on and off, and the data current is accordingly programmed into data lines Data[2i−1] and Data[2i].

In addition, a data current corresponding to the green color and a data current corresponding to the red color are alternately applied to a signal line SP[i+1], switches S5 and S6 are alternately turned on and off, and the data current is accordingly programmed into data lines Data[2i+1] and Data[2i+2].

Hereinafter, a demultiplexing method according to the fourth exemplary embodiment of the present invention will be described with reference to FIGS. 10 and 11.

In the first subfield, when the switches S1, S3 and S5 are turned on and the switches S2, S4 and S6 are turned off while the select signal is applied to the scan line select1[1], a data signal is applied only to data lines Data[2i−3], Data[2i−1] and Data[2i+1] and not to data lines Data[2i−2], Data[2i] and Data[2i+2].

Accordingly, when an emission control signal is applied to a scan line select2[1], subpixels 110R, 110B and 120G emit light and subpixels 110G, 120R and 120B go into a blank state and do not emit light.

Thereafter, when the switches S2, S4 and S6 are turned on and the switches S1, S3 and S5 are turned off while the select signal is applied to the scan line select1[2], a data signal is applied to only the data lines Data[2i−2], Data[2i] and Data[2i+2] and not to the data lines Data[2i−3], Data[2i−1] and Data[2i+1].

Accordingly, when an emission control signal is applied to a scan line select2[2], subpixels (not shown) coupled to the scan line select1[2] and the data lines Data[2i−2], Data[2i] and Data[2i+2] emit light, and subpixels (not shown) coupled to the scan line select1[2] and the data lines Data[2i−3], Data[2i−1] and Data[2i+1] do not emit light.

In this way, by alternately turning on and off the switches S1 through S6, the data signal is programmed into only subpixels coupled to odd-numbered scan lines and odd-numbered data lines, and programmed also into subpixels coupled to even-numbered scan lines and even-numbered data lines. The subpixels into which the data signal is programmed emit light until the subpixels go into the blank state by the second subfield.

In the second subfield, as shown in FIG. 11, when the select signal is applied to the scan line select1[1], the switches S2, S4 and S6 are turned on and the switches S1, S3 and S5 are turned off. Thus, a data signal is applied only to data lines Data[2i−2], Data[2i] and Data[2i+2] and not to data lines Data[2i−3], Data[2i−1] and Data[2i+1].

Accordingly, when an emission control signal is applied to a scan line select2[1], subpixels 110G, 120R and 120B emit light and subpixels 110R, 110B and 120G go into the blank state and do not emit light.

Thereafter, when the switches S1, S3 and S5 are turned on and the switches S2, S4 and S6 are turned off while the select signal is applied to the scan line select1[2], a data signal is applied to the data lines Data[2i−3], Data[2i−1] and Data[2i+1] and not to the data lines Data[2i−2], Data[2i] and Data[2i+2].

Accordingly, when an emission control signal is applied to the scan line select2[2], subpixels coupled to the scan line select1[2] and the data lines Data[2i−3], Data[2i−1] and Data[2i+1] emit light, and subpixels coupled to the scan line select1[2] and the data lines Data[2i−2], Data[2i] and Data[2i+2] go into the blank state and do not emit light.

In this way, by alternately turning on and off the switches S1 through S6, the data signal is programmed into only subpixels coupled to odd-numbered scan lines and even-numbered data lines, and programmed also into subpixels coupled to even-numbered scan lines and odd-numbered data lines.

Thus, by alternately lighting adjacent subpixels according to the fourth exemplary embodiment of the present invention, a coarse presentation of images on the display panel can be prevented. Accordingly, the image quality of the display can be improved.

As apparent from the above description, by demultiplexing a data signal outputted from the data driver and applying the demultiplexed data signal to the data lines, the number of integrated circuits of the data driver can be reduced.

In addition, by driving pixel circuits according to the duty driving method, dividing a field into a plurality of subfields, and lightening pixels alternately, flickers occurring in the display panel can be removed.

Furthermore, by lighting subpixels representing red, green and blue colors alternately in a plurality of subfields, a coarse presentation of images on the display panel can be prevented.

While a demultiplexer and a display using the demultiplexer have been described in the exemplary embodiments of the present invention, the embodiments are provided as examples to which the concept of the present invention is applied. Therefore, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A display comprising:
a display area including:
a plurality of data lines for transmitting a data signal representing images; and
a plurality of pixel circuits coupled to the plurality of data lines;
a plurality of first signal lines;
a data driver coupled to the plurality of first signal lines for time-dividing a first signal corresponding to the data signal and transmitting the time-divided first signal to the plurality of first signal lines; and
a demultiplexer for demultiplexing the time-divided first signal transmitted from the plurality of first signal lines to generate the data signal,
wherein the demultiplexer applies the data signal to at least two of the plurality of data lines including a first data line and a second data line,
wherein one field includes a plurality of subfields,
wherein the demultiplexer applies the data signal to the corresponding first data line for a first period of a first subfield of the plurality of subfields, and applies the data signal to the corresponding second data line for a second period of a second subfield of the plurality of subfields, and
wherein the first signal is a signal corresponding to at least two colors.

2. The display of claim 1, wherein the demultiplexer applies a blank signal to the first and second data lines while the data signal is not applied to the first and second data lines.

3. The display of claim 2, wherein each of the plurality of pixel circuits includes at least one light emitting element for emitting light corresponding to the magnitude of the data signal, and
the pixel circuits coupled to the first data line start emitting light in the first subfield, and the pixel circuits coupled to the second data line start emitting light in the second subfield.

4. The display of claim 3, wherein the demultiplexer applies the data signal to the corresponding second data line for a third period of the first subfield, and wherein the demultiplexer applies the data signal to the corresponding first data line for a fourth period of the second subfield.

5. The display of claim 1, wherein the demultiplexer applies the data signal to the first and second data lines such that at least one non-light emitting pixel circuit exists between adjacent light emitting pixel circuits.

6. The display of claim 1, wherein the demultiplexer includes a plurality of switches, at least one of the plurality of switches having one electrode coupled to the first signal line and the other electrode coupled to each of the data lines including the first and second data lines.

7. The display of claim 6, wherein the display area includes pixel circuits representing different first to third colors arranged repeatedly in the row direction, and pixel circuits representing substantially equal colors are coupled to the plurality of data lines.

8. The display of claim 7, wherein the data driver time-divides and outputs the data signal corresponding to colors of the pixel circuits coupled to the first and second data lines.

9. The display of claim 1, wherein the first data line is an odd-numbered data line and the second data line is an even-numbered data line.

10. The display of claim 1, wherein the data signal is supplied in the form of a current.

11. A display panel comprising:
a display area including a plurality of data lines for transmitting a data signal, a plurality of scan lines for transmitting a select signal, and a plurality of pixels respectively coupled to the plurality of data lines and the plurality of scan lines;
a data driver for generating the data signal to be programmed into the plurality of pixel circuits, time-dividing the data signal to be applied to adjacent first and second data lines of the plurality of data lines, and outputting the time-divided data signal as a first signal; and
a demultiplexer for demultiplexing the first signal to generate the data signal and applying the data signal to the first and second data lines,
wherein the display area includes pixels representing at least two colors arranged repeatedly in the row direction, and
wherein the demultiplexer applies the data signal to the data lines such that at least one non-light emitting pixel exists between adjacent light emitting pixels.

12. The display panel of claim 11, wherein a period is provided during which the demultiplexer applies the data signal to one of the two data lines which is substantially equal to a horizontal period during which the select signal is applied to the scan lines.

13. The display panel of claim 11, wherein the demultiplexer applies the data signal to one of the two data lines, and wherein the demultiplexer applies a blank signal to the other of the two data lines.

14. The display panel of claim 11, wherein a field includes at least a first and a second subfield, and the select signal is sequentially applied to the scan lines in each subfield.

15. The display panel of claim 14, wherein, in the first subfield, the demultiplexer applies the data signal to the first data line while the select signal is applied to a first scan line of the plurality of scan lines, and wherein the demultiplexer applies the data signal to the second data line while the select signal is applied to a second scan line of the plurality of scan lines.

16. The display of claim 15, wherein, in the second subfield, the demultiplexer applies the data signal to the second data line while the select signal is applied to the first scan line, and wherein the demultiplexer applies the data signal to the first data line while the select signal is applied to the second scan line.

17. A demultiplexer for demultiplexing a data signal time-divided by a data driver, comprising:
a first switch for transmitting the data signal to a first data line in response to a first control signal; and
a second switch for transmitting the data signal to a second data line in response to a second control signal,
wherein one field includes a least a first subfield and a second subfield,
wherein the data signal is a data current corresponding to at least two colors, and
wherein the first and second control signals are alternately in different sequences in the first and second subfields.

18. A driving method for a display panel including a plurality of data lines for transmitting a data signal, a plurality of scan lines for transmitting a select signal, and a plurality of pixels, each of which includes at least two first and second pixel groups representing different colors, coupled to the plurality of data lines and the plurality of scan lines, respectively,
and one field divided into at least two subfields,
the driving method comprising:
applying the select signal to the plurality of scan lines sequentially in each of the subfields; and
transmitting the data signal alternately to data lines to which the first pixel group and the second pixel group are respectively coupled while applying the select signal,
wherein the first and second pixel groups are set such that at least one non-light emitting pixel exists between adjacent light emitting pixels in each of the subfields.

19. The driving method of claim 18, wherein in one subfield and another subfield of the at least two subfields, orders in which the data signal is transmitted to the data lines to which the first pixel group and the second pixel group are respectively coupled are differently set.

20. The driving method of claim 18, wherein the data signal is supplied in the form of a current, and each of the plurality of pixels emits light corresponding to the magnitude of the data signal programmed through the data lines.
